(19) United States
(12) Patent Application Publication
(10) Pub. No.: US 2021/0102424 A1
(43) Pub. Date: Apr. 8, 2021

(54) MITER JOINT CONNECTORS FOR FRAME ASSEMBLY AND METHOD OF CONNECTING MITERED FRAME MEMBERS

(71) Applicant: MirrorMate, LLC, Charlotte, NC (US)

(72) Inventors: Lisa Huntting, Charlotte, NC (US); Gary van Deursen, Naples, FL (US)

(21) Appl. No.: 16/905,503

(22) Filed: Jun. 18, 2020

Related U.S. Application Data
(63) Continuation of application No. 29/708,006, filed on Oct. 2, 2019.
Application No. 29/708,006 is a continuation of application No. 29/708,011, filed on Oct. 2, 2019.
Application No. 29/708,011 is a continuation of application No. 29/708,012, filed on Oct. 2, 2019.
Application No. 29/708,012 is a continuation of application No. 29/708,014, filed on Oct. 2, 2019.

(51) Int. Cl. E06B 3/968; E06B 3/972

(52) U.S. Cl. CPC E06B 3/9682; E06B 3/9725

(57) ABSTRACT

A connector is adapted for securing into a fixed position two frame members that are positioned to define a common miter joint and aligned slots to collectively define a single correspondingly-shaped connector opening. The connector includes a peripheral configuration corresponding to a peripheral configuration of the correspondingly-shaped opening. The connector may have a peripheral surface having on predetermined portions thereof a plurality of stepwise ridges adapted to contact with reduced friction only spaced-apart areas of sidewalls of the correspondingly-shaped opening. The connector may have at least one void in the connector to permit deformation sufficient to accommodate variations between the shape of the connector and the shape of the correspondingly-shaped opening. A method of using the connector is also disclosed.

### CROSS-REFERENCE TO RELATED APPLICATION

This application claims the priority of U.S. Design Patent Application Nos. 29/708,006, 29/708,011, 29/708,012, and 29/708,014, all entitled “Dovetail Element for Mirror Frame Attachment,” all filed on Oct. 2, 2019, and all of which are hereby incorporated by reference in the entirety.

### TECHNICAL FIELD AND BACKGROUND OF THE INVENTION

The invention relates generally to the field of frames and, more particularly to the assembly of picture and mirror frames using miter joint connectors to join adjacent, mitered frame members.

There exists a wide variety of frame joinder methods. One such prior art frame assembly method includes inserting connectors of various shapes into slots or pockets formed in the edges of mitered butt joints by routing, for example. These connectors have varying shapes, such as an “hourglass,” “bowtie,” or “I”-shape, all defined by a peripheral shape that corresponds generally to the shape of the slots into which they are wedged to fix the frame members together in the desired right-angle orientation. These connectors also are referred to as “keys.” An example of this prior art joinder technique can be seen in U.S. Pat. No. 7,654,025, in which a solid “I” shaped connector is used to connect two frame members together. These types of connectors are typically small, hard pieces of plastic, wood, or metal with shapes that closely correspond to the opening defined by the aligned slots formed in the ends of the frame members into which the connector will be placed. Slight variances in the size/shape of the connectors or the slots can make assembly of the frame difficult and result in a misaligned or cracked frame. In addition, frame members often include one or more recessed channels extending along the back side of the frame members to allow for other fixtures, such as mirror mounting brackets, to be positioned on or along the frame while still allowing the assembled frame to fit flush against a surface. The presence of such one or more channels, in addition to the slight variations in the size/shape of the connectors or the slots, also can make assembly of the frame more difficult and result in a cracked frame during assembly.

There is therefore a need for a connector which reduces or eliminates the effect of variances in the sizes and shape of connectors and the respective openings into which they are placed. In addition, there is a need for a connector which reduces or eliminates the potential damage done during assembly of frames having recessed channels.

### SUMMARY OF THE INVENTION

It is therefore an object of the present invention to provide a connector that has the ability to compensate for variances in the manufacture of frame elements with slots for receiving frame member connectors.

It is another object of the invention to provide a connector that is easily installed. It is another object of the invention to provide a connector that reduces cost by eliminating damaged or misaligned frames.

It is another object of the invention to provide a connector that has surface features that reduce or eliminate friction associated with driving the connector into correspondingly-shaped slots.

These and other objects and advantages of the present invention are achieved in the preferred embodiments set forth below by providing a connector adapted for securing into a fixed position two frame members that are positioned to define a common miter joint and aligned slots to collectively define a single correspondingly-shaped opening for such connector. The connector includes a peripheral configuration corresponding to a peripheral configuration of the correspondingly-shaped opening, and a peripheral surface having on predetermined portions thereof a plurality of stepwise ridges adapted to contact with reduced friction only spaced-apart areas of sidewalls of the correspondingly-shaped opening. A method of using the connector is also disclosed.

According to another embodiment of the invention, the peripheral configuration of the connector includes diverging, opposed pairs of legs defining an “X” shape.

According to another embodiment of the invention, the peripheral configuration of the connector is hourglass shaped.

According to another embodiment of the invention, the connector includes at least one void therein.

According to another embodiment of the invention, the void is internal with regard to the peripheral configuration of the connector.

According to another embodiment of the invention, the connector includes first and second opposed distal end portions and a reduced-size proximal center portion having a void adapted to permit the connector to be compressed from an initial interference fit into the correspondingly-shaped opening.

According to another embodiment of the invention, the connector includes first and second opposed distal end portions, each having a respective void therein, and a reduced-size proximal center portion.

According to another embodiment of the invention, opposing ends of the connector have rounded edges.

According to another embodiment of the invention, the plurality of stepwise ridges are formed on substantially entire longitudinally-extending peripheral walls of the connector.

According to another embodiment of the invention, the plurality of stepwise ridges comprise right angles.

According to another embodiment of the invention, a connector is adapted for securing into a fixed position two frame members that are positioned to define a common miter joint and aligned slots to collectively define a single correspondingly-shaped opening for such connector, and includes a peripheral configuration of the connector having peripheral edges and corresponding to a peripheral configuration of the correspondingly-shaped opening, a peripheral surface having a plurality of stepwise right-angle ridges formed on a substantially entire longitudinally-extending peripheral walls of the connector and adapted to contact with reduced friction only spaced-apart areas of sidewalls of the correspondingly-shaped opening, and at least one void formed in the connector.

According to another embodiment of the invention, the peripheral configuration of the connector includes diverging, opposed pairs of legs defining an “X” shape.

According to another embodiment of the invention, the peripheral configuration of the connector is hourglass shaped.

According to another embodiment of the invention, the plurality of stepwise ridges comprise right angles.

According to another embodiment of the invention, a method for locking two mitered frame members of a frame into a fixed position is disclosed, and includes the steps of providing a connector adapted for locking into a fixed position two frame members that are positioned to define a common miter joint and aligned slots to collectively define a single correspondingly-shaped opening, comprising a peripheral configuration of the connector corresponding to a peripheral configuration of the correspondingly-shaped opening, and a peripheral surface having on predetermined portions thereof a plurality of stepwise ridges adapted to contact with reduced friction only spaced-apart areas of sidewalls of the correspondingly-shaped opening, abutting the two frame members end to end to form a miter joint, forming at least one correspondingly-shaped opening defined by adjoining slots in the two frame member ends, and inserting the connector into the correspondingly-shaped opening.

According to another embodiment of the invention, the method includes the step of using a mallet to complete insertion of the connector into the opening.

### BRIEF DESCRIPTION OF THE DRAWINGS

The present invention is best understood when the following detailed description of the invention is read with reference to the accompanying drawings, in which:

FIG. 1 is a top perspective view of a connector according to one embodiment of the invention;

FIG. 2 is a bottom perspective view of the connector shown in FIG. 1;

FIG. 3 is a side elevation of the connector shown in FIG. 1;

FIG. 4 is an enlarged side elevation of the connector shown in FIG. 1 showing for clarity an exaggerated potential deformation resulting from insertion into a miter joint slot;

FIG. 5 is a top perspective view of a connector according to another embodiment of the invention;

FIG. 6 is a bottom perspective view of a connector according to another embodiment of the invention;

FIG. 7 is a side elevation of the connector shown in FIG. 6;

FIG. 8 is a perspective view of a connector according to another embodiment of the invention;

FIG. 9 is a side elevation of the connector shown in FIG. 8;

FIG. 10 illustrates a prior art connector assembly and related method;

FIGS. 11-15 are sequential perspective views of connectors according to a preferred embodiment of the invention being inserted into a frame; and

FIG. 16 is a flow chart for inserting a connector into a frame.

### DETAILED DESCRIPTION OF THE PREFERRED EMBODIMENT

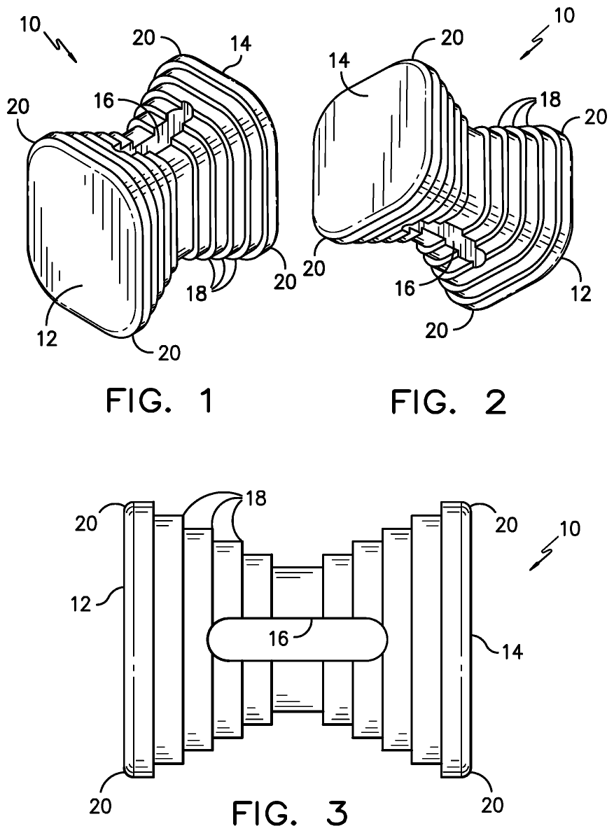

Referring now to FIGS. 1-3, a connector 10 according to one embodiment of the invention is shown. At least one connector 10 is used to join two adjacent mitered frame members. When two frame members of the frame are joined at a miter joint, slots formed in the abutting edges form a shape generally corresponding to the shape of the connector 10 into which the connector 10 is inserted for connecting together the two frame members.

The connector 10 may be made of plastic, metal, wood, or any other suitable material. The connector 10 according to a preferred embodiment has an “hourglass”, “I” or “bowtie” shape with two relatively flat ends 12, 14 and a central void 16 that preferably extends through the connector 10 from one side to the other side. The connector 10 is symmetrical end to end and side to side with an inward taper from both ends 12, 14. This symmetry increases the versatility of the connector 10 and reduces user error by increasing the possible orientations which the connector 10 may be inserted into the frame slots. One resulting feature of the connector 10 is that the slots in the frame may not be completely filled due to the shape of the connector 10. The void 16 may have a uniform cross-section as it passes through the connector 10, or the cross-section may vary. Dimensions of the void 16 may vary based on the material, overall dimensions of the connector 10, the material of the frame into which the connector 10 may be inserted, manufacturing capabilities or any other number of variables.

The exterior walls defining the perimeter of the connector 10 have graduated stepwise ridges 18 that incrementally narrow the dimensions of the connector 10 as the ridges 18 approach the center of the connector 10 from respective ends 12, 14. Dimensions of the ridges 18 may be uniform, or may vary from end 12 to end 14. These stepwise ridges 18 create sufficient friction for holding the connector 10 in place within the slot in the frame and allow for manufacturing variations of both the connectors 10 and the frame slots. The ridges 18 have the effect of reducing the friction and therefore the force required to insert the connector 10 into the slot. This results from the reduced surface area contact between the connector 10 and the surfaces defining the slot. This design permits a slight interference fit of the connector 10 with the opening. While ridges 18 are shown, it is also envisioned that in other embodiments the perimeter surface may be relatively smooth or have a slight texture.

Additionally, spaces defined by the straight, flat, walls of the slot and the ridges allow for accommodation of slight variations in the size and shape of the slot in relation to the dimensions of the connector 10. The void 16 provides a further degree of “give” that may be required for a connector 10 to properly fit into a given slot.

The relatively flat ends 12, 14 may have rounded corners 20 on one or more corners of each flat end 12, 14. These rounded corners 20 also allow for an easier insertion of the connector 10 into the slot. Manufacturing variations in the connectors 10 and in the edges of the frame openings at the miter joints may result in sizing variations and these rounded corners 20 reduce the significance and impact of the variations, particularly at the edges and corners of the frame openings.

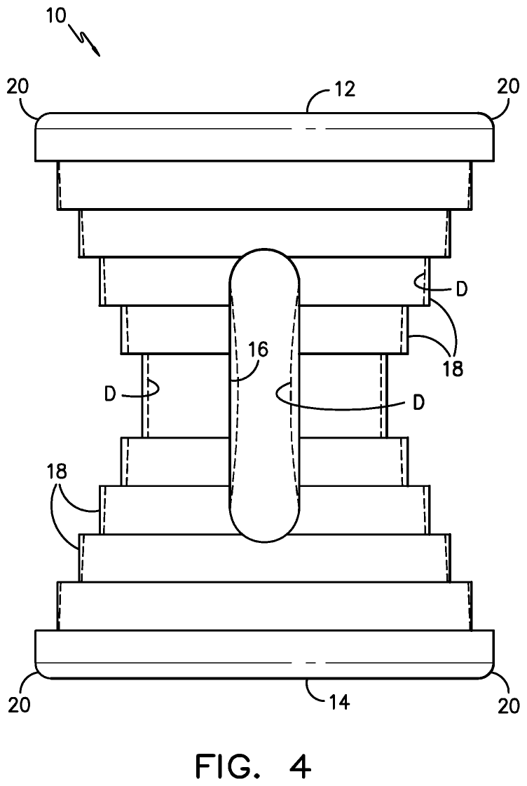

As shown in FIG. 4, the connector 10 allows for the deformations “D” to further decrease the force required as the connectors 10 are inserted into the slots. The prior art connector according to FIG. 1 has virtually no ability to deform in a similar manner. The ability of the connector to deform slightly makes it easier to insert the connector into the slots, and thus reduces damage caused by the need to use excessive force to insert the connector 10 into the slot.

While FIG. 4 shows relatively exaggerated deformations “D,” the range of deformations “D” may vary. It is typically desirable to achieve only slight deformations so that the overall structural integrity of the connector 10 is not compromised. The void 16 decreases the rigidity of the connector 10 such that deformations within the void 17 and deformations D of the stepwise ridges 18 are possible.

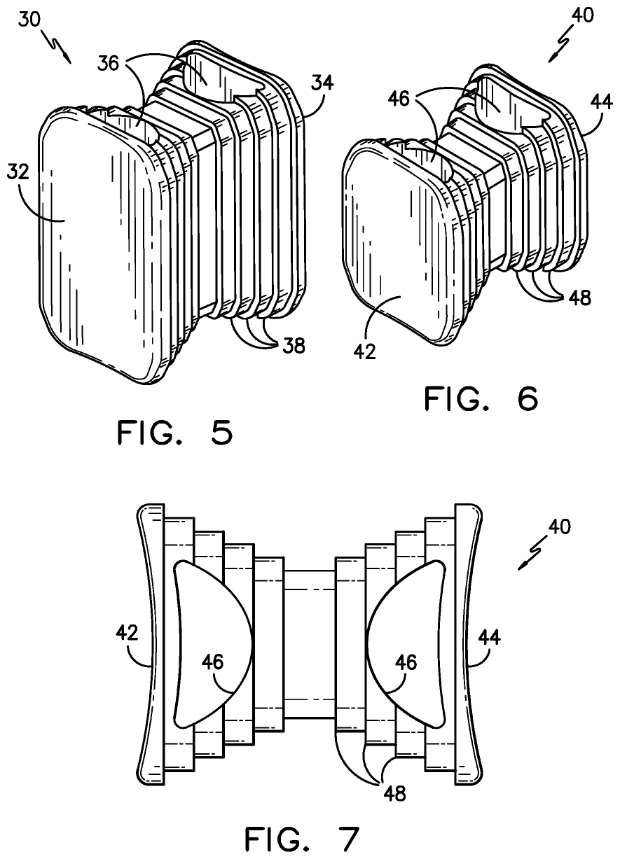

Referring now to FIGS. 5-7, a connector 30 is shown that includes a pair of opposed voids 36 formed proximate two relatively flat ends 32, 34. A plurality of stepwise ridges 38 extend around the perimeter of the connector 30, which is generally rectilinear, and such ridges serve the purposes described above with reference to connector 10. The voids 36 are mirrored with voids 36 proximate respective flat ends 32, 34. While the cross-sectional shape of the voids 36 is a crescent, other shapes are also possible, the operative purpose being to facilitate the structural integrity of the connector 30 while permitting an appropriate degree of deformation as the connector 10 is inserted into a slot. The size, position, and shape of the voids 36 may also be selected based on other factors such as the material of the frame members and the connector.

FIGS. 6 and 7 illustrate another connector 40 which has two ends 42, 44 with a generally rounded-corner square cross-section. Two voids 46 are formed proximate the respective ends 42, 44. A plurality of stepwise ridges 46 extend around the perimeter of the connector 40 and serve the purposes described above with reference to connector 10.

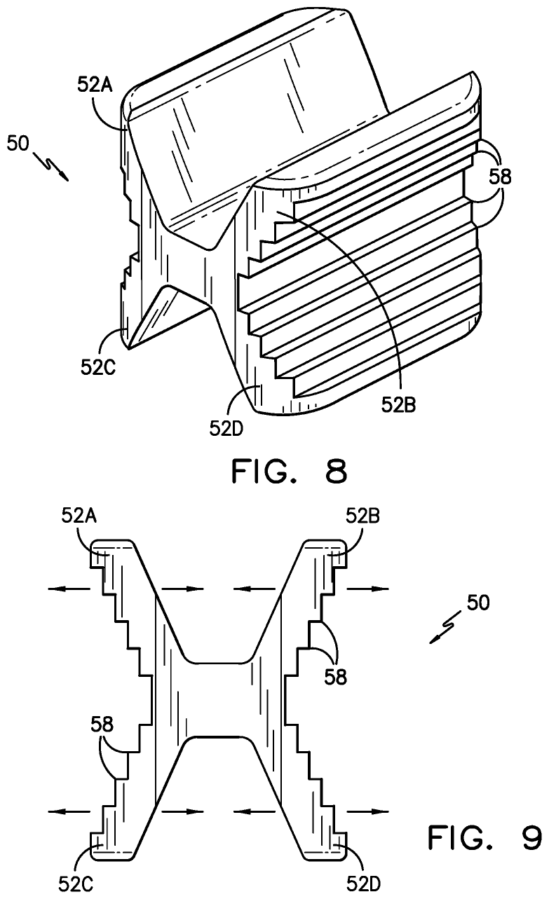

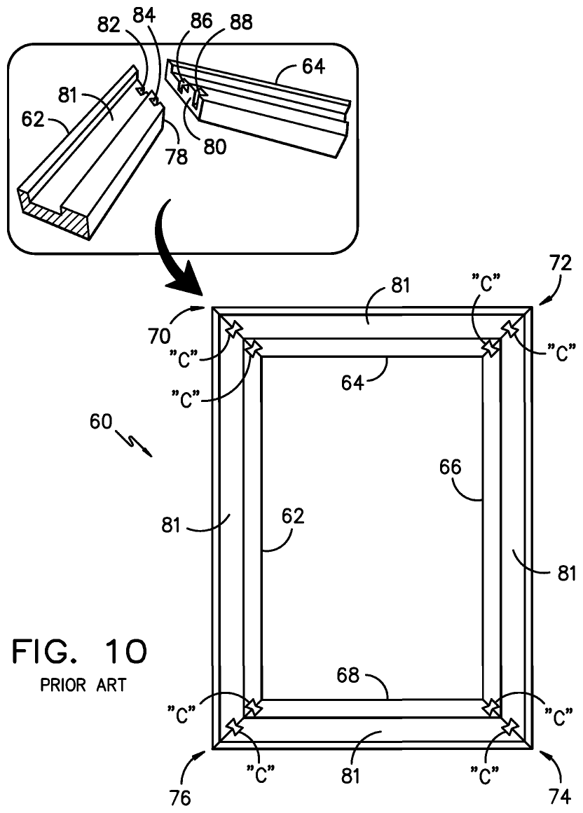

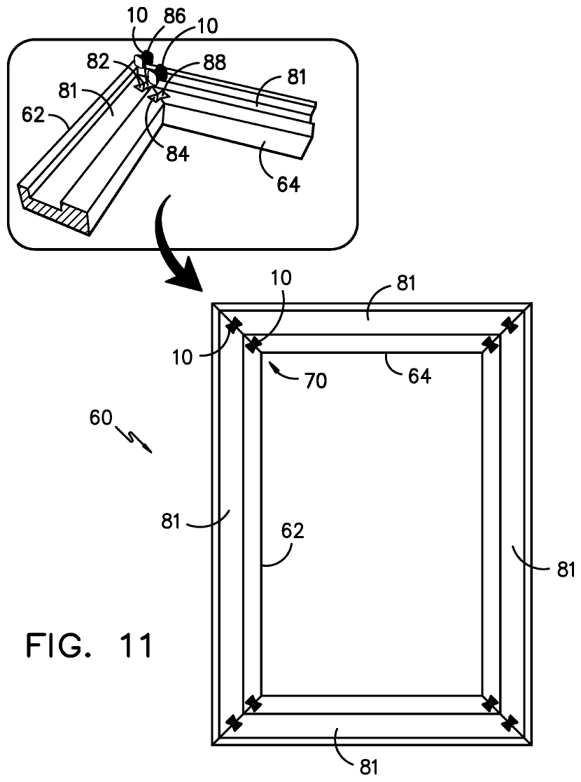

A further alternative embodiment of a connector 50, shown in FIGS. 8 and 9, has an ‘X’ shape formed by diverging legs 52A, 52B and 52C, 52D. In this shape the connector 50 is adaptable to a wide variation of slot configurations with the legs 52A, B, C and D adapted to flex inwardly and outwardly, indicated by arrows as needed. The plurality of stepwise ridges 58 reduce the surface area contact between the connector 50 and the interior walls of the slot, reducing friction and accommodating slight variations in shape and size of the connector 50 as well as the slot.

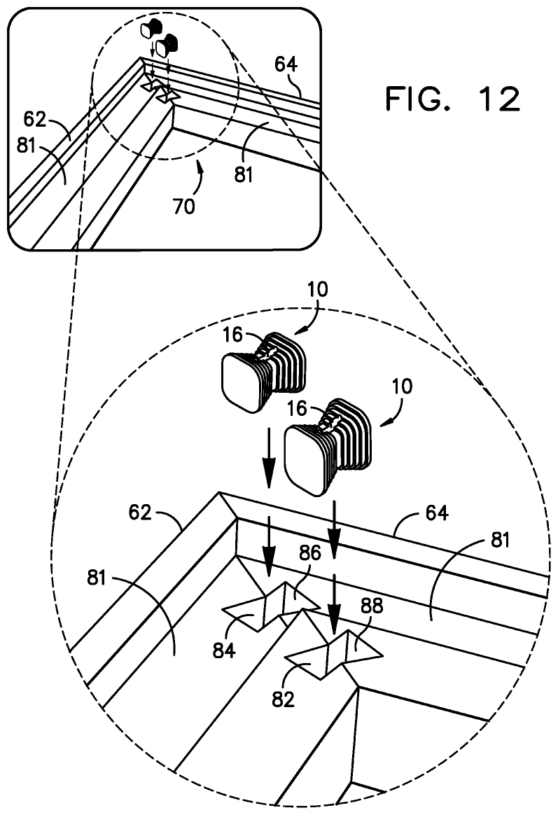

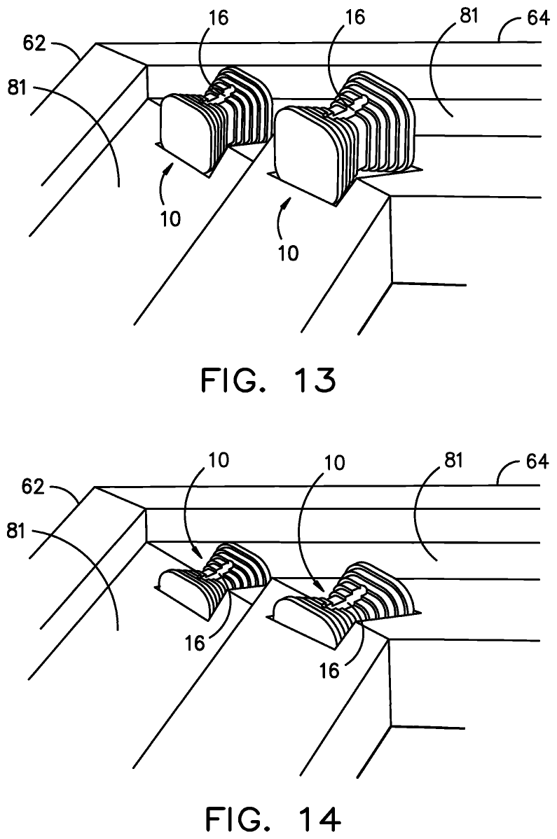

Referring now to FIG. 10, a prior art method of assembling one miter joint of a frame 60 is shown. A traditional picture or mirror frame 60 has four frame members 62, 64, 66, 68 defining four miter joints 70, 72, 74, 76. The method shown in FIG. 10 utilizes a conventional prior art “hourglass” or “I”-shaped solid connector “C” that must be inserted into aligned pairs of slots 82, 84 and 86, 88. These slots 82, 84 and 86, 88 may be routed into the ends, molded into the frame member ends 78, 80 in the case of plastic or resin frames, or created by any other suitable method. As shown in FIG. 10 as well as FIGS. 11-15, these frame members may include recessed channels 81 extending along the back side of the frame members 62, 64, 66, and 68. These channels 81 may be useful in providing space for other fixtures, such as mirror mounting brackets, to be positioned on the frame members while still allowing the assembled frame to fit flush against a surface. The presence of the recessed channel 81 may require differing length connectors, as shown in FIG. 12.

Once the frame members 62, 64 are joined together with ends 78 and 80 properly aligned, slots 82, 86 are positioned to receive the connector “C.” The prior art connector “C” is typically manually inserted partially into the aligned slots 82, 86 and then hammered into its final position essentially flush the surrounding surface of the frame members 62, 64. Another connector “C” is fixed into the aligned slots 84, 88, connectors “C” fixed into the aligned slots in the miter joints 72, 74 and 76 in the same manner to arrive at the assembly shown in FIG. 10.

Referring now to FIGS. 11-15, the same frame 60 may be assembled using any of the novel connectors 10, 30, 40, or 50 shown and described above. By way of illustration, two connectors 10 are shown being utilized to join the frame members 62 and 64, defining miter joint 70. Following the sequence of FIGS. 12-15, the connector 10 is progressively inserted into the aligned slots 82, 86. A degree of size variation or misalignment is compensated for by the ability of the connector 10 with the void 16 to change shape slightly as it moves into the aligned slots 82, 86. At the same time, the ridges 18 of connector 10 reduce the surface area and thus the friction between the walls of the aligned slots 82, 86 and the connector 10 allowing both shape accommodation and an easier insertion while maintaining the configuration required to provide a properly-aligned, symmetrical frame.

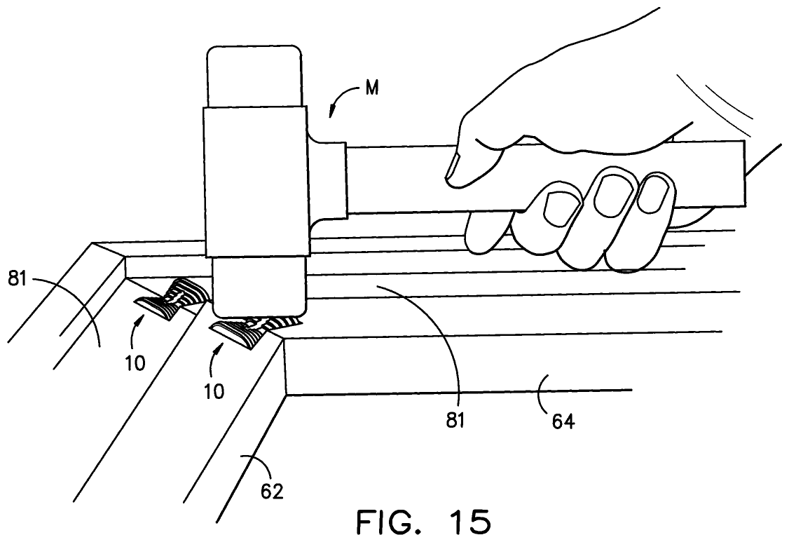

If necessary, a mallet “M” may be used to complete the insertion as shown in FIG. 15. Depending on the frame 60, the aesthetics, or other purposes, the connectors 10 may be inserted to be flush or countersunk in relation to the surrounding surface of the frame 60.

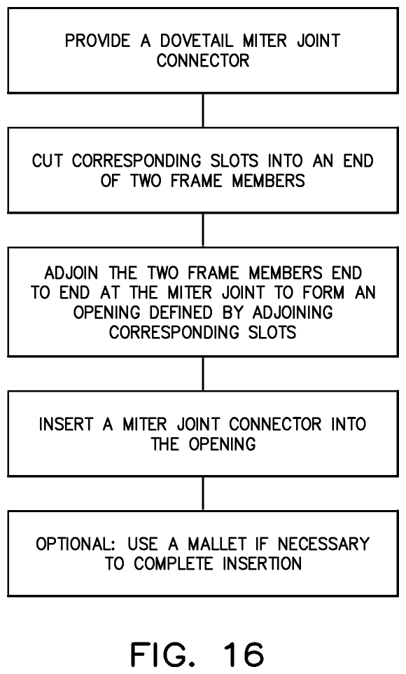

The method according to the invention is summarized in FIG. 16. A connector according to any of the embodiments of the invention is provided. Slots are routed or otherwise formed into mitered ends of frame members in positions wherein alignment of the mitered ends define an opening generally corresponding to the configuration of the specific connector to be used to join the frame members. The frame members are aligned and a connector is inserted into the opening and progressively pressed into the opening until it is at least flush in relation to the surrounding surface of the frame. A mallet or other suitable implement may be used to complete the insertion step of the method.

A connector and a method of forming a frame using a connection according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A connector adapted for securing into a fixed position two frame members that form a miter joint and aligned slots to collectively define a single correspondingly-shaped opening, comprising:
(a) a peripheral configuration corresponding to a peripheral configuration of the correspondingly-shaped opening; and
(b) at least one through void formed in the connector for providing surface deformation to the connector as required to fit into a correspondingly-shaped opening.

2. The connector according to claim 1, wherein the peripheral configuration of the connector is symmetrical from end to end and from side to side.

3. The connector according to claim 1, wherein the peripheral configuration of the connector includes diverging, opposed pairs of legs defining an “X” shape.

4. The connector according to claim 1, wherein the peripheral configuration of the connector is hourglass shaped.

5. The connector according to claim 1, wherein the at least one void passes through the connector in a direction transverse to a longitudinal axis of the connector.

6. The connector according to claim 1, wherein the at least one void comprises two spaced apart voids.

7. The connector according to claim 1, and including first and second opposed distal end portions and a reduced-size proximal center portion having a void adapted to permit the connector to be compressed from an initial interference fit into the correspondingly-shaped opening.

8. The connector according to claim 1, and including first and second opposed distal end portions, each having a respective void therein, and a reduced-size proximal center portion.

9. The connector according to claim 1, wherein opposing ends of the connector have rounded edges.

10. A connector adapted for securing into a fixed position two frame members that form a miter joint and aligned slots to collectively define a single correspondingly-shaped opening, comprising:
a. a peripheral configuration corresponding to a peripheral configuration of the correspondingly-shaped opening;
b. a peripheral surface having on predetermined portions thereof a plurality of stepwise ridges adapted to contact with reduced friction only spaced-apart areas of sidewalls of the correspondingly-shaped opening; and
c. at least one through void formed in the connector for providing surface deformation to the connector as required to fit into a correspondingly-shaped opening.

11. The connector according to claim 10, wherein the peripheral configuration of the connector is symmetrical from end to end and from side to side.

12. The connector according to claim 10, wherein the peripheral configuration of the connector includes diverging, opposed pairs of legs defining an “X” shape.

13. The connector according to claim 10, wherein the peripheral configuration of the connector is hourglass shaped.

14. The connector according to claim 10, wherein the at least one void passes through the connector in a direction transverse to a longitudinal axis of the connector.

15. The connector according to claim 10, wherein the at least one void comprises two spaced apart voids.

16. The connector according to claim 10, and including first and second opposed distal end portions and a reduced-size proximal center portion having a void adapted to permit the connector to be compressed from an initial interference fit into the correspondingly-shaped opening.

17. The connector according to claim 10, and including first and second opposed distal end portions, each having a respective void therein, and a reduced-size proximal center portion.

18. The connector according to claim 10, wherein opposing ends of the connector have rounded edges.

19. The connector according to claim 10, wherein the plurality of stepwise ridges are formed on substantially entire longitudinally-extending peripheral walls of the connector.

20. The connector according to claim 10, wherein the plurality of stepwise ridges comprise right angles.

21. A connector adapted for securing into a fixed position two frame members that are positioned to form a miter joint and aligned slots to collectively define a single correspondingly-shaped opening, comprising:
(a) a peripheral configuration having peripheral edges and corresponding to a peripheral configuration of the correspondingly-shaped opening;
(b) a peripheral surface having a plurality of stepwise right-angle ridges formed on a substantially entire longitudinally-extending peripheral walls of the connector and adapted to contact with reduced friction only spaced-apart areas of sidewalls of the correspondingly-shaped opening; and
(c) at least one void formed in the connector.

22. The connector according to claim 21, wherein the peripheral configuration of the connector includes diverging, opposed pairs of legs defining an “X” shape.

23. The connector according to claim 21, wherein the peripheral configuration of the connector is hourglass shaped.

24. The connector according to claim 21, wherein the plurality of stepwise ridges comprise right angles.

25. A method for securing two mitered frame members of a frame into a fixed position, comprising the steps of:
(a) providing a connector adapted for securing into a fixed position two frame members that are positioned to form a common miter joint and aligned slots to collectively define a single correspondingly-shaped opening, comprising a peripheral configuration corresponding to a peripheral configuration of the correspondingly-shaped opening and at least one void formed in the connector;
(b) abutting the two frame members end to end to form a miter joint;
(c) forming at least one correspondingly-shaped opening defined by adjoining slots in the two frame member ends; and
(d) inserting the connector into the correspondingly-shaped opening to secure the frame members in the fixed position.

26. The method according to claim 25, further comprising the step of using a mallet to complete insertion of the connector into the opening.

27. The method according to claim 25, wherein the connector has two through voids.

28. The method according to claim 25, wherein the connector has a shape selected from the group of shapes consisting of an hourglass shape and an “X” shape.

29. An hourglass-shaped connector adapted for securing into a fixed position two frame members that are positioned to define a common miter joint and aligned slots to collectively define a single hourglass-shaped opening, comprising:
(a) the hourglass-shaped connector having a peripheral configuration corresponding to a peripheral configuration of the correspondingly-shaped opening; and
(b) at least one through void formed in the connector for providing surface deformation to the connector as required to fit into a correspondingly-shaped opening.

30. The connector according to claim 29, wherein the connector includes first and second through voids extending through the connector proximate opposed enlarged ends of the connector.

31. The connector according to claim 29, wherein the connector includes first and second through voids extending through the connector proximate opposed enlarged ends of the connector and transverse to opposed enlarged ends of the connector.

32. The connector according to claim 29, wherein the connector includes first and second through voids extending through the connector proximate opposed enlarged ends of the connector and aligned with a lengthwise dimension of the connector.

33. The connector according to claim 29, wherein the connector includes a through void extending transversely of the connector proximate a central narrow waist of the connector and aligned with an elongate widthwise dimension of the connector.
